(19) United States
(12) Patent Application Publication
(10) Pub. No.: US 2023/0183613 A1
(43) Pub. Date: Jun. 15, 2023

(54) USE OF CARBOXYMETHYLATED POLYMER OF LYSINES AS DISPERSING AGENT AND COMPOSITIONS COMPRISING THE SAME

(71) Applicant: BASF SE, Ludwigshafen Am Rhein (DE)

(72) Inventors: Alexandros LAMPROU, Shanghai (CN); Xu LU, Shanghai (CN); Helmut WITTELER, Ludwigshafen (DE); Yan KANG, Shanghai (CN); Juergen DETERING, Ludwigshafen (DE); Markus HARTMANN, Ludwigshafen (DE); Heike WEBER, Ludwigshafen (DE); Claudia ESPER, Ludwigshafen (DE)

(21) Appl. No.: 17/998,560

(22) PCT Filed: May 5, 2021
(86) PCT No.: PCT/EP2021/061804

§ 371 Date: Nov. 11, 2022

(30) Foreign Application Priority Data
May 12, 2020 (WO) PCT/CN2020/089847

(51) Int. Cl. C11D 3/37; C11D 3/39; C11D 17/00; C11D 11/00

(52) U.S. Cl. CPC C11D 3/3723; C11D 3/394; C11D 11/0017; C11D 17/0008

(57) ABSTRACT

Disclosed herein are carboxymethylated polylysines as dispersing agents and/or chelating agents. Additionally disclosed are detergent compositions and peroxy bleaching compositions including carboxymethylated polylysines. Further disclosed is a method for formulating a detergent composition or a peroxy bleaching composition with the carboxymethylated polylysines.

### FIELD OF THE INVENTION

The present invention relates to use of a carboxymethylated polymer of lysine as a dispersing agent, particularly in a detergent composition or a bleaching composition. The present invention also relates to the detergent composition and peroxy bleaching composition comprising a carboxymethylated polymer of lysine.

### BACKGROUND ART

Nowadays, dispersing agents play an important role in various industrial and household formulations, for example in laundry detergent formulations for the prevention of graying of textile and in automatic dishwashing detergent formulations for the prevention of scaling on the ware.

Chelating agent is also an important additive in industrial and household formulations, for example for washing, cleaning and bleaching processes, especially in hard water areas.

Most of dispersing agents and chelating agents used today are petroleum-based rather than bio-based. Recently, bio-based products and products comprising bio-based ingredients have attracted consumer’s interest due to the sustainability of biomass resource. With such a trend, bio-based dispersing agents and chelating agents bring new challenges for the manufacturers, in particular in household detergent applications.

For applications that need both chelating and dispersing efficacies to avoid undesirable phenomenon such as scaling or soil depositing, for example in washing, cleaning processes, there is a trend of developing additives having both chelating and dispersing abilities, i.e., multifunctional additives to reduce total number of species and/or total amount of additives in a single formulation. As examples of existing multifunctional additives, phosphate and phosphonate are well-known for excellent chelating and dispersing power and have been widely used in the past. However, environmental-friendly phosphorus-free additives become more attractive with the improvement of public environmental protection awareness and more environmental regulatory requirements worldwide.

There is thus a need, to provide a bio-based chemical which is useful as a substitute to the petroleum-based dispersing agents or chelating agents, particularly one having both chelating and dispersing functions, for example for detergent applications.

### SUMMARY OF THE INVENTION

It is an object of the present invention to provide a phosphorus-free, bio-based and biodegradable additive, particularly useful for detergent compositions and bleaching compositions, which could function as chelating and/or dispersing agents.

It has been found that the object of the present invention can be achieved by a bio-based polymer, i.e., carboxymethylated polymer of lysine.

In one aspect, the present invention relates to use of a carboxymethylated polymer of lysine having a degree of modification (DM) of at least 50% as a dispersing agent and/or chelating agent.

In another aspect, the present invention relates to use of a carboxymethylated polymer of lysine having a degree of modification (DM) of at least 50% in a detergent composition or a peroxy bleaching composition.

In a further aspect, the present invention relates to a detergent composition or a peroxy bleaching composition, which comprises a carboxymethylated polymer of lysine having a degree of modification (DM) of at least 50%.

It has been surprisingly found that the carboxymethylated polymer of lysine shows comparable or even better chelating and/or dispersing performances than commercially available chelating or dispersing agents. It has also been found that the carboxymethylated polymer of lysine can function as chelating and dispersing agents at the same time and may particularly provide promising commercial opportunities in detergent and bleaching compositions.

### DETAILED DESCRIPTION OF THE INVENTION

The present invention now will be described in details hereinafter. It is to be understood that the present invention may be embodied in many different ways and shall not be construed as limited to the embodiments set forth herein. Unless mentioned otherwise, all technical and scientific terms used herein have the same meaning as commonly understood by one of ordinary skill in the art to which the present invention belongs.

As used herein, the singular forms “a”, “an” and “the” include plural referents unless the context clearly dictates otherwise.

As used herein, the terms “comprise”, “comprising”, etc. are used interchangeably with “contain”, “containing”, etc. and are to be interpreted in a non-limiting, open manner. That is, e.g., further components or elements may be present. The expressions “consists of” or “consists essentially of” or cognates may be embraced within “comprises” or cognates.

As used herein, the term “polymer of lysine” is intended to refer to any polymers comprising repeating units obtained from condensation of lysine molecules with each other and intended to encompass linear and branched polymeric structures. The term “polymer of lysine” may be abbreviated as “polylysine”, which two terms will be used interchangeably hereinafter.

As used herein, the term “bio-based” is intended to indicate the specified material may be derived from a biomass resource.

As used herein “renewable additive” refers to an additive component that is derived from renewable feedstock and contains renewable carbon.

As used herein “biodegradable”, generally refers to a material that degrades from the action of naturally occurring microorganisms, such as bacteria, fungi, and algae; environmental heat: moisture; or other environmental factors.

As used herein, the term “carboxymethylated polymer of lysine” is intended to refer to the polymer of lysine which has been modified by carboxymethylation of the free amino groups present in the polymer of lysine such that carboxyl groups are introduced into the polymer, which may be abbreviated as “carboxymethylated polylysine” hereinafter. It will be understood that the terms “carboxymethylated polymer of lysine” and “carboxymethylated polylysine” are intended to include partially or completely neutralized forms with respect to the carboxyl groups.

As used herein, the K-value, when mentioned for the carboxymethylated polylysine according to the present invention, refers to corresponding parameters of the polymers without carboxymethylation, unless the context clearly dictates otherwise.

### Carboxymethylated Polylysines

Carboxymethylated polylysines having linear or branched structures and derivatives thereof have been known for several decades. For example, Kazuo Uehara et al. describes preparation of a carboxymethylated polylysine and certain physical properties thereof in “Preparation and properties of poly(N^{ε},N^{ε}-dicarboxymethyl-L-lysine)”, Polymer, 1979, Vol 20, 670-674. DE 3701665 A describes a carboxymethylated polylysine and use thereof to form a polymeric metal-complex useful as a diagnostic and radiotherapeutic agent. WO2011/031284 A1 describes a polylysine modified with aminocarboxylate groups, such as iminodiacetic acid, nitrilotriacetic acid. The resulting polymers is useful in prolonging the blood circulation of active agents. The modified polylysines such as carboxymethylated polylysines have been studied for their applications particularly in medical and pharmaceutical fields. Applications of carboxymethylated polylysines in detergent or bleaching compositions have never been mentioned in the state of art.

The carboxymethylated polylysines useful for the present invention may be prepared by carboxymethylation of polylysines. Particularly, carboxymethylation of polylysines occurs at the free amino groups remaining in the polylysines. The carboxymethylation may be carried out via any conventional processes for carboxymethylation of amines to provide amino-carboxylic acids. For example, polylysines may be carboxymethylated simply via a carboxymethylation agent, such as iodioacetic acid as described in “Preparation and properties of poly(N^{ε},N^{ε}-dicarboxymethyl-L-lysine)”, Kazuo Uehara et al., Polymer, 1979, Vol 20, 670-674, or sodium chloroacetate as described in US 2,860,164A. Alternatively, the polylysines may be carboxymethylated via reaction of the amino groups with formaldehyde and hydrogen cyanide or sodium cyanide under respective conditions as described in US 2,860,164A. There is no particular restriction to the process for preparing the carboxymethylated polylysines in the present invention.

The carboxymethylated polylysines useful for the present invention may be in partially or completely neutralized form with respect to the carboxyl groups depending on the process and conditions for the preparation. In case of partially or completely neutralized form, the carboxyl groups may be in form of ammonium salts or alkali metal salts such as sodium or potassium salts.

As polylysines to be carboxymethylated, which is bio-based and biodegradable, both linear polylysines and branched polylysines (i.e. having a branched structure) are useful. It is known that polylysines may have linear or branched structures depending on the production process. For example, e-linear polylysines are generally prepared by a microbial fermentation process as well known in the art. Branched polylysines are generally resulted from thermal polycondensation of lysine due to the fact that lysine has one reactive carboxyl group and two reactive amino groups (α-NH₂ and ε-NH₂) per molecule. For the purpose of the present invention, the type of polylysine structures (linear or branched), the arrangement of those structural units, and the degree of branching are all not critical. Branched polylysines may be preferable just from the cost point of view.

In a particular embodiment of the present invention, the carboxymethylated polylysines are carboxymethylated homopolymers of lysines, also referred to homopolysines.

More particularly, the carboxymethylated polylysines are linear or branched carboxymethylated hompolylysines.

In a preferred embodiment, the carboxymethylated polylysines are carboxymethylated e-linear polylysines. The e-linear polylysines may be prepared by a microbial fermentation or may be those commercially available.

In another preferred embodiment of the present invention, the carboxymethylated polylysines are carboxymethylated branched homopolylysines obtained by thermal polycondensation of lysine.

In a preferred embodiment of the present invention, the carboxymethylated polylysines have a degree of modification (DM) of at least 50%, preferably at least 70 %, more preferably at least 80%, and up to 90% or even 100%. Herein, the degree of modification (DM) is determined in accordance with the following equation:

$$\text{DM} \text{=} \frac{\left(\text{moles of carboxymethyl groups}\right)}{2 \times \left(\text{moles of lysine monomeric units}\right)} \times 100 \%$$

Wherein the moles of carboxymethyl groups and the moles of lysine monomeric units are determined according to the resonance signals assigned to respective protons as measured by ¹H NMR in D₂O.

Preferably, the carboxymethylated polylysines are prepared from polylysines having a K-value in the range of 8 to 25, more preferably 10 to 20, as determined with 1 wt % solution of respective polylysine in water at 23° C. according to DIN ISO 1628-1. More particularly, the carboxymethylated polylysines are prepared from branched homopolylysines having a K-value in the range of 8 to 25, more preferably 10 to 14, or from e-linear homopolylysines having a K-value in the range of 10 to 25, more preferably 17 to 22.

The K-value is often referred to as intrinsic viscosity and is an indirect measure of molecular weight of polymers.

The carboxymethylated polylysines have a number average molecular weight (Mn) in the range of 800 to 17,000 g/mol, preferably in the range of 1,000 to 15,000 g/mol, and/or have a weight average molecular weight (Mw) in the range of 900 to 18,000 g/mol, preferably in the range of 1,100 to 16,000 g/mol.

Particularly, in case of carboxymethylated branched homopolylysines, the carboxymethylated polylysines have a number average molecular weight (Mn) in the range of 800 to 7,000 g/mol, preferably in the range of 1,000 to 6,000 g/mol, and/or have a weight average molecular weight (Mw) in the range of 900 to 11,000 g/mol, preferably in the range of 1,100 to 7,000 g/mol. In case of carboxymethylated e-linear homopolylysines, the carboxymethylated polylysines have a number average molecular weight (Mn) in the range of 5,000 to 17,000 g/mol, preferable in the range of 6,000 to 15,000 g/mol, and/or have a weight average molecular weight (Mw) in the range of 5,500 to 18,000 g/mol, preferable in the range of 6,500 to 16,000 g/mol.

It has been found that the carboxymethylated polylysines are useful for providing chelating and/or dispersing functions in detergent compositions and for providing chelating functions in peroxy bleaching compositions.

### Detergent and Bleaching Compositions

### Detergent Compositions

According to the present invention, the detergent composition may be any compositions comprising a surfactant or a surfactant mixture to provide cleansing efficacy. Particularly, the detergent composition is a laundry detergent composition or a detergent composition for cleaners. The term “detergent composition for cleaners” includes compositions for cleaners for home care and for industrial or institutional applications. Particularly, the detergent composition for cleaners includes compositions for dishwashing, especially hand dishwashing and automatic dishwashing and ware-washing, and compositions for hard surface cleaning such as, but not limited to compositions for bathroom cleaning, kitchen cleaning, floor cleaning, descaling of pipes, window cleaning, car cleaning including truck cleaning, furthermore, open plant cleaning, cleaning-in-place, metal cleaning, disinfectant cleaning, farm cleaning, high pressure cleaning, but not laundry detergent compositions.

There is no restriction to the formulation of the detergent composition. The carboxymethylated polylysines are useful for any conventional formulations of detergent composition such as laundry detergent composition or detergent composition for cleaners. It is to be understood that the carboxymethylated polylysines may be used in the detergent compositions in addition to or in place of the chelating agent and/or dispersing agent which would otherwise be comprised in a conventional formulation of the detergent composition.

In some embodiments of the present invention, the laundry detergent composition comprises the carboxymethylated polylysines in an amount of 0.5 to 30%, preferably 1 to 20%, and more preferably 1 to 10% by weight based on the total solid content of the detergent composition.

In some other embodiments of the present invention, the detergent composition for cleaners comprises the carboxymethylated polylysines in an amount of 0.5 to 30%, preferably 1 to 20%, more preferably 1 to 10% by weight based on the total solid content of the detergent composition.

As the essential component providing the cleansing efficacy for the detergent composition, at least one of cationic, anionic, nonionic and amphoteric surfactants may be comprised depending on the specific applications and desired performances of the detergent composition.

### Nonionic Surfactants

Useful nonionic surfactants may include, but are not limited to condensation products of (1) alcohols with ethylene oxide, of (2) alcohols with ethylene oxide and a further alkylene oxide, of (3) polypropylene glycol with ethylene oxide or of (4) ethylene oxide with a reaction product of ethylenediamine and propylene oxide, fatty acid amides, and semipolar nonionic surfactants.

Condensation product of alcohols with ethylene oxide derives for example from alcohols having a C₈ to C₂₂-alkyl group, preferably a C₁₀ to C₁₈-alkyl group, which may be linear or branched, primary or secondary. The alcohols are condensed with about 1 to 25 mol and preferably with about 3 to 18 moles of ethylene oxide per mole of alcohol.

Condensation products of alcohols with ethylene oxide and a further alkylene oxide may be constructed according to the scheme R—O—EO—AO or R—O—AO—EO, where R is a primary or secondary, branched or linear C₈ to C₂₂-alkyl group, preferably a C₁₀ to C₁₈-alkyl group, EO is ethylene oxide and AO comprises an alkylene oxide, preferably propylene oxide, butylene oxide or pentylene oxide.

Condensation products of polypropylene glycol with ethylene oxide comprise a hydrophobic moiety preferably having a molecular weight of from about 1,500 to about 1,800. The addition of up to about 40 moles of ethylene oxide onto this hydrophobic moiety leads to amphiphilic compounds.

Condensation products of ethylene oxide with a reaction product of ethylenediamine and propylene oxide comprises a hydrophobic moiety consisting of the reaction product of ethylenediamine and propylene oxide and generally having a molecular weight of from about 2,500 to about 3,000. Ethylene oxide is added up to a content, based on the hydrophobic unit, of about 40% to about 80% by weight of polyoxyethylene and a molecular weight of from about 5,000 to about 11,000.

Fatty acid amides may be those of following formula

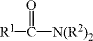

wherein
R¹ is an alkyl radical having 7 to 21 and preferably 9 to 17 carbon atoms, and
R², independently from each other, is hydrogen, C₁ to C₄-alkyl, C₁ to C₄-hydroxyalkyl or (C₂H₄O)ₓH where x varies from 1 to 3.

Preference is given to C₈ to C₂₀-fatty acid amides such as monoethanolamides, diethanolamides and diisopropanolamides.

As the semipolar nonionic surfactants, water-soluble amine oxides, water-soluble phosphine oxides and water-soluble sulfoxides each having at least one C₈ to C₁₈-alkyl group, preferably C₁₀ to C₁₄-alkyl group may be mentioned. Preference is given to C₁₀-C₁₂-alkoxyethyldihydroxyethylamine oxides.

In some embodiment, weakly foaming or low-foam nonionic surfactants are preferable, for example in automatic dishwashing compositions. Particularly, following nonionic surfactants of the formulae (I), (II) and (III) may be mentioned,

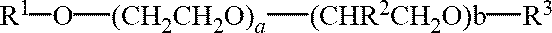

wherein
R¹ is a linear or branched C₈ to C₂₂-alkyl radical,
R² and R³, independently of one another, are hydrogen or a linear or branched C₁ to C₁₀-alkyl radical, where R² is preferably methyl, and
a and b, independently of one another, are 0 to 300;

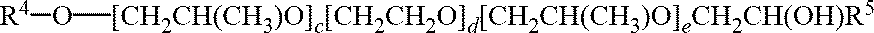

wherein
R⁴ is a linear or branched aliphatic C₄ to C₂₂-hydrocarbyl radical or mixtures thereof,
R⁵ is a linear or branched C₂ to C₂₆-hydrocarbyl radical or mixtures thereof,
c and e are values between 0 and 40, and
d is a value of at least 15;

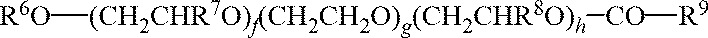

wherein
R⁶ is a branched or unbranched C₈ to C,₆-alkyl radical,
R⁷, R⁸, independently of one another, are H or a branched or unbranched C₁ to C₅-alkyl radical,
R⁹ is an unbranched C₅ to C₁₇-alkyl radical,
f, h, independently of one another, are a number from 1 to 5, and
g is a number from 13 to 35.

The surfactants of the formulae (I), (II) and (III) can either be random copolymers or block copolymers, preferably in the form of block copolymers, as described in US9796951 B2, which will be incorporated herein by reference.

### Anionic Surfactants

Useful anionic surfactants may include but are not limited to alkenyl- or alkyl benzenesulfonates, alkanesulfonates, olefinsulfonates, alkyl ester sulfonates, alkyl sulfates, alkyl ether sulfates, alkyl carboxylates (soap). The counter-ions present are alkali metal cations, preferably sodium or potassium, alkaline earth metal cations, for example calcium or magnesium, and also ammonium and substituted ammonium compounds, for example mono-, di- or triethanol ammonium cations and mixtures of the aforementioned cations therefrom.

Alkenyl- or alkyl benzenesulfonates may comprise a branched or linear, optionally hydroxyl-substituted alkenyl or alkyl group, preferably linear C₉ to C₂₅-alkyl group.

Alkane sulfonates are available on a large industrial scale in the form of secondary alkanesulfonates wherein the sulfo group is attached to a secondary carbon atom of the alkyl moiety. The alkyl can in principle be saturated, unsaturated, branched or linear and optionally hydroxyl substituted. Preferred secondary alkane sulfonates comprise linear C₉ to C₂₅-alkyl radicals, preferably C₁₀ to C₂₀-alkyl radicals and more preferably C₁₂ to C₁₈-alkyl radicals.

Olefinsulfonates are obtained by sulfonation of C₈ to C₂₄ and preferably C₁₄ to C₁₆-α-olefins with sulfur trioxide and subsequent neutralization. Owing to their production process, these olefinsulfonates may comprise minor amounts of hydroxy alkanesulfonates and alkanedisulfonates.

Alkyl ester sulfonates derive for example from linear ester of C₈ to C₂₀-carboxylic acids, i.e., fatty acids, which are sulfonated with sulfur trioxide. Compounds of following formula are preferred

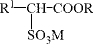

wherein

R¹ is a C₈ to C₂₀-alkyl radical, preferably C₁₀ to C,₁₆-alkyl and R is a C₁ to C₆-alkyl radical, preferably a methyl, ethyl or isopropyl group. Particular preference is given to methyl ester sulfonates where R¹ is C₁₀ to C₁₆-alkyl.

Alkyl sulfates are surfactants of the formula ROSO₃M, where R is C₁₀ to C₂₄-alkyl and preferably C₁₂ to C₁₈-alkyl. M is a counter-ion as described at the beginning for anionic surfactants.

Alkyl ether sulfates have the general structure RO(A)ₘSOaM, where R is a C₁₀ to C₂₄-alkyl and preferably C₁₂ to C₁₈-alkyl radical, wherein A is an alkoxy unit, preferably ethoxy and m is a value from about 0.5 to about 6, preferably between about 1 and about 3, and M is a cation, for example sodium, potassium, calcium, magnesium, ammonium or a substituted ammonium cation.

Alkyl carboxylates are generally known by the term “soap”. Soap can be manufactured on the basis of saturated or unsaturated, preferably natural, linear C₈ to C₁₈-fatty acid. Saturated fatty acid soaps include for example the salts of lauric acid, myristic acid, palmitic acid, stearic acid, hydrogenated erucic acid and behenic acid, and in particular soap mixtures derived from natural fatty acids, for example coconut, palm kernel or tallow fatty acids. Known alkenylsuccinic acid salts may also be used together with soap or as substitutes for soap.

Further anionic surfactant are salts of acylamino carboxylic acids, acyl sarcosinates, fatty acid-protein condensation products obtained by reaction of fatty acid chlorides with oligopeptides; salts of alkylsulfamido carboxylic acids; salts of alkyl and alkylary ether carboxylic acids; sulfonated polycarboxylic acids, alkyl and alkenyl glycerol sulfates, such as oleyl glycerol sulfates, alkylphenol ether sulfates, alkyl phosphates, alkyl ether phosphates, isethionates, such as acyl isethionates, N-acyltaurides, alkyl succinates, sulfosuccinates, monoesters of sulfosuccinates (particularly saturated and unsaturated C₁₂ to C₁₈-monoesters) and diesters of sulfosuccinates (particularly saturated and unsaturated C₁₂ to C₁₈-diesters), sulfates of alkylpolysaccharides such as sulfates of alkylpolyglycosides and alkypolysaccharides such as sulfates of alkylpolyglycosides and alkyl polyethoxy carboxylates such as those of the formula RO(CH₂CH₂)ₖCH₂COOM, where R is C₈ to C₂₂-alkyl, k is a number from 0 to 10 and M is a cation.

### Cationic Surfactants

Useful cationic surfactants may be substituted or unsubstituted straight chain or branched quaternary ammonium salts of R¹N(CH₃)₃⁺X⁻, R¹R²N(CH₃)₂⁺X⁻, R¹R²R³N(CH₃)⁺X_{′} or R¹R²R³R⁴N⁺X⁻, wherein R¹, R², R³ and R⁴ independently from each other are unsubstituted C₈ to C₂₄-alkyl and preferably C₈ to C₁₈-alkyl, hydroxylalkyl having 1 to 4 carbon atoms, phenyl, C₂ to C₁₈-alkenyl, C₇ to C₂₄-aralkyl, (C₂H₄O)ₓH where x is from about 1 to about 3, the alkyl radical optionally comprising one or more ester groups, and X is a suitable anion. Useful cationic surfactants may also be cyclic quaternary ammonium salts.

### Amphoteric/Zwitterionic Surfactants

Useful amphoteric surfactants may be aliphatic derivatives of secondary or tertiary amines, or aliphatic derivatives of heterocyclic secondary and tertiary amines, in which the aliphatic radical may be straight or branched-chain and where one of the aliphatic substituents contains at least about 8 carbon atoms, or from about 8 to about 18 carbon atoms, and at least one of the aliphatic substituents contains an anionic water-solubilizing group, e.g. carboxy, sulfonate, sulfate. Suitable amphoteric surfactants also include sarcosinates, glycinates, taurinates, and mixtures thereof. Examples of the species as the amphoteric surfactants are known in the art, for example from WO2005095569A1.

Useful zwitterionic surfactants may be derivatives of secondary and tertiary amines, derivatives of heterocyclic secondary and tertiary amines, or derivatives of quaternary ammonium, quaternary phosphonium or tertiary sulfonium compounds. Suitable Examples of zwitterionic surfactants include, but are not limited to, betaines such as alkylbetaines and alkylamide betaines, such as N-alkyl-N,N-dimethyl-N-carboxymethylbetaines, N-(alkylamidopropyl)-N,N-dimethyl-N-carboxymethylbetaines, alkyldipolyethoxybetains, alkylamine oxides, and sulfo and hydroxy betaines such as N-alkyl-N,N-dimethylammino-1-propane sulfonate, each having a linear or branched C₈ to C₂₂-alkyl, preferably C₈ to C₁₈-alkyl radical and more preferably C₁₂ to C₁₈-alkyl.

In an exemplary embodiment of the present invention, a laundry detergent composition may comprise 0.1 to 80% by weight of at least one surfactant selected from anionic surfactants, amphoteric surfactants and nonionic surfactants, based on the total solid content of the detergent composition. Some preferred laundry detergent composition of the present invention may contain at least one anionic or non-ionic surfactant.

In another exemplary embodiment of the present invention, a detergent composition for cleaners may comprise 0.1 to 80% by weight of at least one surfactant selected from anionic surfactants, amphoteric surfactants and nonionic surfactants, based on the total solid content of the detergent composition. Some preferred detergent composition for cleaners of the present invention may contain at least one anionic or non-ionic surfactant.

### Auxiliaries

The detergent composition may further comprise customary auxiliaries which serve to modify the performance characteristics of the detergent composition.

Suitable auxiliaries for detergent compositions may include but are not limited to builder such as complexing agent other than carboxymethylated polylysines, ion exchange agent and precipitating agent, bleaching agent, bleach activators, corrosion inhibitor, foam boosters, antifoams, dyes, fillers, color care agent, optical brightener, disinfectant, alkalis, antioxidant, thickener, perfume, solvent, solubilizer, softener and antistat. By way of example, some auxiliaries will be described hereinbelow.

Generally, the detergent composition may comprise at least one builder selected from organic and inorganic builders. Examples of suitable inorganic builders are sodium sulfate or sodium carbonate or silicates, in particular sodium disilicate and sodium metasilicate, zeolites, sheet silicates, in particular those of the formula α—Na₂Si₂O₅, β—Na₂Si₂O₅, and δ—Na₂Si₂O₅. Examples of suitable organic builders are fatty acid sulfonates, α-hydroxypropionic acid, alkali metal malonates, fatty acid sulfonates, alkyl and alkenyl disuccinates, tartaric acid diacetate, tartaric acid monoacetate, oxidized starch, and polymeric builders, for example polycarboxylates and polyaspartic acid.

The detergent composition may comprise the builder, for example, in a total amount of 10 to 70% by weight, preferably up to 50% by weight, based on the total solid content of the detergent composition. In the context of the present invention, the carboxymethylated polylysines are not counted as the builder.

The detergent composition may comprise at least one antifoam, selected for example from silicone oils and paraffin oils. The antifoams may be in a total amount of 0.05 to 0.5% by weight, based on the total solid content of the detergent composition.

The detergent composition may comprise at least one bleaching agent. The bleaching agent may be selected from chlorine bleach and peroxide bleach.

Peroxide bleach may be selected from inorganic peroxide bleach and organic peroxide bleach. Preferred inorganic peroxide bleaches are selected from alkali metal percarbonate, alkali metal perborate and alkali metal persulfate. In solid detergent compositions for hard surface cleaning and in solid laundry detergent compositions, alkali metal percarbonates, especially sodium percarbonates, are preferably used in coated form. Such coatings may be of organic or inorganic nature. Examples are glycerol, sodium sulfate, silicate, sodium carbonate, and combinations thereof, for example combinations of sodium carbonate and sodium sulfate. Examples of organic peroxide bleaching agents are percarboxylic acids.

Suitable chlorine-containing bleaches are, for example, 1,3-dichloro-5,5-dimethylhydantoin, N-chlorosulfamide, chloramine T, chloramine B, sodium hypochlorite, calcium hypochlorite, magnesium hypochlorite, potassium hypochlorite, potassium dichloroisocyanurate and sodium dichloroisocyanurate. The laundry detergent composition and the detergent compositions for cleaners may comprise the chlorine-containing bleach, for example, in a total amount of from 3 to 10% by weight, based on the total solid content of the detergent composition.

The detergent composition may also comprise at least one bleach activator for example N-methylmorpholinium-acetonitrile salts (“MMA salts”), tri-methylammonium acetonitrile salts, N-acylimides such as N-nonanoylsuccinimide, 1,5-diacetyl-2,2-dioxohexahydro-1,3,5-triazine (“DADHT”) or nitrile quats (trimethylammonium acetonitrile salts). Further examples of bleach activators are tetraacetylethylenediamine (TAED) and tetraacetylhexylenediamine.

The detergent composition may comprise at least one corrosion inhibitor. Examples of suitable corrosion inhibitors are triazoles, in particular benzotriazoles, bisbenzotriazoles, aminotriazoles, alkylaminotriazoles, phenol derivatives such as hydroquinone, pyrocatechol, hydroxyhydroquinone, gallic acid, phloroglucinol or pyrogallol. The detergent composition may comprise the corrosion inhibitor in a total amount of 0.1 to 1.5% by weight, based on the total solid content of the detergent composition.

The detergent composition may also comprise at least one enzyme. Examples of enzymes are lipases, hydrolases, amylases, proteases, cellulases, esterases, pectinases, lactases and peroxidases. The enzyme may be comprised in the detergent composition, particularly the laundry detergent composition and the detergent composition for cleaners in an amount of up to 5% by weight, preferably 0.1 to 3% by weight based on the total solid content of the detergent composition. The enzyme may be stabilized, for example with the sodium salt of at least one C₁ to C₃-carboxylic acid or C₄ to C₁₀-dicarboxylic acid.

Suitable species and dosages of the conventional auxiliaries for the detergent composition, particularly laundry detergent composition and detergent composition for cleaners, are well-known in the art and may be found in for example WO 2017174413A1, WO 2015187757A1, US9796951B2 and US20190136152A1.

### Peroxy Bleaching Compositions

Peroxy bleaching agents are widely used in various processes such as textile whitening, cellulosic fiber pulp whitening, hair decoloring and surface disinfection, due to the strong oxidation ability of peroxides. It is known that peroxides are generally sensitive to heavy metal ions such as Fe, Cu, Mn, Ni, Co, Zn, Pb and Cd ions since heavy metal ions could catalyze the decomposition of peroxides. Even small amount of heavy metal ions may inevitably have an adverse impact on the bleaching effect.

As a conventional measure to stabilize peroxides such as hydrogen peroxide against heavy metal ions, an additive which could chelating or complexing the heavy metal ions (e.g. EDTA, DTPA, NTA) is often used in peroxy bleaching compositions comprising hydrogen peroxide or a precursor of hydrogen peroxide which could generate hydrogen peroxide during bleaching process.

It has been found that carboxymethylated polylysines are useful as stabilizer of peroxy bleaching agent. Particularly, the peroxy bleaching agent may be those conventionally used for bleaching cellulosic fibrous materials such as wood, cotton, linen, jute and other materials of a cellulosic nature, which may be in form of individual fibers (e.g. wood pulp or cotton fiber), as well as yarns, tows, webs, fabrics (woven or non-woven) and other aggregates of such fibers, and for bleaching synthetic textiles including polyamides, viscose, rayon, and polyesters.

In an embodiment of the present invention, the carboxymethylated polylysines are comprised as a stabilizer in a peroxy bleaching composition for bleaching cellulose fiber pulps. Cellulose fiber pulps generally comprising a certain amount of heavy metal ions such as Fe, Cu and Mn ions, which need to be masked such that the bleaching effect would not be impacted adversely.

In a particular embodiment, the peroxy bleaching composition for bleaching cellulose fiber pulps is in a form of aqueous hydrogen peroxide solution. The aqueous hydrogen peroxide solution generally comprises an inorganic alkali metal basic material, such as sodium hydroxide, sodium carbonate, sodium silicate and mixtures thereof. The inorganic alkali metal basic material was used to endow a desirable pH in the range of 7.5 to 12.5 to the aqueous hydrogen peroxide solution. The carboxymethylated polylysines may be comprised in an amount of 0.01 to 3% by weight, preferably 0.1 to 1% by weight in the aqueous hydrogen peroxide solution, based on the total weight of the solution.

In another particular embodiment, the carboxymethylated polylysines and the peroxide component are comprised separately in the peroxy bleaching composition for bleaching cellulose fiber pulps. In this embodiment, the carboxymethylated polylysines and the hydrogen peroxide are not mixed until both being incorporated into the cellulose fiber pulp to be bleached. The carboxymethylated polylysines may be incorporated into the cellulose fiber pulp in a dosage of 0.01 to 3% by weight, preferably 0.1 to 1% by weight, more preferably 0.2 to 0.8% by weight, based on the weight of the cellulose fiber pulps. The specific dosage of carboxymethylated polylysines may vary depending on the heavy metal contents of the pulp, hydrogen oxide dosage, bleaching process and the like. It is also desirable to use an inorganic alkali metal basic material, such as sodium hydroxide, sodium carbonate, sodium silicate and mixtures thereof such that the bleaching is carried out at a pH in the range of 7.5 to 12.5.

The following Examples are provided to illustrate the present invention, which however are not intended to limit the present invention.

### EXAMPLES

### Description of Materials Used in Examples

Polymer PA-1: Polyacrylic acid, sodium salt, aqueous solution, pH 8 (10%), solid content 40 wt%, Mw 4000 g/mol, commercially available from BASF
Polymer PA-2: Polyacrylic acid, sodium salt, aqueous solution, pH 8 (10%), solid content 45 wt%, Mw 1200 g/mol, commercially available from BASF
Polymer PAA: Acrylic acid/2-Acrylamido-2-methylpropane sulfonic acid copolymer, sodium salt, granules, solid content 92 wt%, commercially available from BASF
EDTA Liquid: Ethylenediaminetetraacetic acid, tetrasodium salt (EDTA-Na₄), active content 40 wt%, commercially available from BASF
MGDA Liquid: Methylglycinediacetic acid, trisodium salt (MGDA-Na₃), aqueous solution, active content 40%, commercially available from BASF
MGDA Granules: Methylglycinediacetic acid, trisodium salt (MGDA-Na₃), granules, active content 85%, commercially available from BASF
Modified PEI: Carboxymethylated polyethyleneimine, aqueous solution, solid content 40%, commercially available from BASF
Anionic Surfactant AES: Sodium Laureth Sulfate, commercially available from BASF
Anionic Surfactant DBS: Linear C_{1O}C₁₃-Alkyl Benzene Sulfonates, commercially available from BASF
Non-ionic Surfactant AEO-1: Ethoxylated C₁₃C₁₅-oxo alcohol (7EO), commercially available from BASF
Non-ionic Surfactant AEO-2: Ethoxylated C₁₂C₁₄-fatty alcohol, (7EO), commercially available from BASF
Edenor® K12-18: Coco fatty acid, commercially available from Henkel
Cublen® NCD732: diethylene triamine penta(methylene phosphonic acid) (DTPMPA), active cotents 32.5%, commercially available from Zschimmer & Schwarz GmbH
Protease: Blaze® Evity®150T, commercially available from Novozymes
Amylase: Stainzyme® Plus Evity® 12L, commercially available from Novozymes
White polyester/cotton fabric: wfk 20A, commercially available from wfk Testgewebe GmbH, Brüggen, Deutschland
White polyester fabric: wfk 30A, commercially available from wfk Testgewebe GmbH, Brüggen, Deutschland
White polyamid fabric: EMPA 406, commercially available from Swissatest Testmaterialien AG, Sankt Gallen, Schweiz
Soiled fabrics: EMPA 117 (Polyester/cotton soiled with blood/milk/ink) commercially available from Swissatest Testmaterialien AG, Sankt Gallen, Schweiz, and wfk 10J (Cotton soiled with tea) commercially available from wfk Testgewebe GmbH, Brüggen, Deutschland.

### Determination of Molecular Weights

The number average (Mn) and weight average (Mw) molecular weights of the modified polymers prepared in following Examples were determined by measuring the unmodified polysines with gel permeation chromatography (GPC) and then converting the measured values to the molecular weights of the modified polymers based on corresponding degree of modification (DM). The unmodified polymers were analyzed in an aqueous eluent containing 0.1 M NaCl and 0.1 wt% trifluoroacetic acid through a cascade of columns (namely, TSKgel G4000, G3000, G3000, 300 × 7.8 mm) at 35° C. and flow rate of 0.8 ml/min. For the analysis, the unmodified polymers were dissolved in the eluent at the concentration of 1.5 mg/ml at room temperature and filtered through a 0.22 µm membrane, 2 h before injection of 100 µl in an Agilent 1100 chromatographic system. The relative molecular weights was characterized by refractive index detection against a calibration curve obtained with polyvinyl pyrrolidone standards, ranging between 620 and 1,060,000 g/mol.

### Preparation Examples

### Example 1: Carboxymethylated Polylysine Homopolymer (Polymer 1)

A 500 ml four-neck flask equipped with a stirrer, an internal thermometer, a gas inlet tube, a condenser with reduced-pressure connection and a Dean-Stark receiver, was charged with 100 g aqueous solution of L-lysine (50 wt%). The mixture was heated with stirring to an internal temperature of 160° C. When the internal temperature reached 100° C., an aqueous solution of 400 g L-lysine (50 wt%) was dosed constantly over 3.5 h with continuous water separation. After a reaction time of 1 hour, water was distilled off further under reduced pressure (670 mbar). Finally, 264 g of water distillate had been collected and the highly viscous polymer was discharged to a silicone container as fast as possible while it was still hot and flowable. K-value was 10.5, as determined with 1 wt% aqueous solution of the polylysine in water at 23° C. according to DIN ISO 1628-1.

A 250 ml four-neck flask equipped with a stirrer, an internal thermometer, a gas inlet tube, a condenser, was charged with 7.86 g sodium chloroacetate, 18.75 g polylysine and 56.25 g D.I. water. Then, the solution was heated up to 70° C. for 5 h. During the first 1.5 h, 31.44 g sodium chloroacetate and 27 g sodium hydroxide (50 wt%) were added into the flask in 3 portions, every 0.5 h. After the reaction mixture was cooled down to 30° C., the polymer was precipitated with excess methanol (1:10 by weight) and filtered. Upon three successive precipitation steps, the product was dried over 16 h in a vacuum oven at 40° C. to obtain the final product with a solid content of 100% and an active content of 94 wt%, as determined by ¹H NMR. The degree of modification (DM) of the polymer as determined by ¹H NMR was 89%, and the molecular weights as determined were Mₙ= 2112 g/mol and M_{w}= 2560 g/mol.

### Example 2: Carboxymethylated Polylysine Homopolymer (Polymer 2)

A 250 ml four-neck flask equipped with a stirrer, an internal thermometer, a gas inlet tube, a condenser, was charged with 2.62 g sodium chloroacetate, 6.25 g e-linear polylysine (from Yiming Biological Products Co., Ltd., Jiangsu, China, K-value 19.6) and 18.75 g D.I. water. Then, the solution was heated up to 70° C. for 5 h. During the first 1.5 h, 10.48 g sodium chloroacetate and 9.0 g sodium hydroxide (50 wt%) were added into the flask in 3 portions, every 0.5 h. The reaction mixture was treated and the product was purified in the same manner as described in Example 1 to obtain the final product with a solid content of 100 % and an active content of 96 wt%. The degree of modification (DM) as determined by ¹H NMR was 90%, and the molecular weights as determined were Mₙ= 11358 g/mol and M_{w}= 11902 g/mol.

### Example 3: Carboxymethylated Polylysine Homopolymer (Polymer 3)

A 500 ml four-neck flask equipped with a stirrer, an internal thermometer, a gas inlet tube, a condenser with reduced-pressure connection and a Dean-Stark receiver, was charged with 100 g aqueous solution of L-lysine (50 wt%). The mixture was heated with stirring to an internal temperature of 160° C. for 45 minutes. Then, an aqueous solution of 400 g L-lysine (50 wt%) was dosed constantly over 3.5 h with continuous water separation. After a reaction time of 1 hour, water was distilled off further under reduced pressure (670 mbar). Finally, 276 g of water distillate had been collected and the highly viscous polymer was discharged to a silicone container as fast as possible while it was still hot and flowable. K-value was measured to be 13.1.

A 250 ml four-neck flask equipped with a stirrer, an internal thermometer, a gas inlet tube, a condenser, was charged with 7.86 g sodium chloroacetate, 18.75 g polylysine and 56.25 g D.I. water. Then, the solution was heated up to 70° C. for 5 h. During the first 1.5 h, 31.44 g sodium chloroacetate and 27 g sodium hydroxide (50 wt%) were added into the flask in 3 portions, every 0.5 h. The reaction mixture was treated and the product was purified in the same manner as described in Example 1 to obtain the final product with a solid content of 100% and an active content of 98 wt%. The degree of modification (DM) as determined by ¹H NMR was 80%, and the molecular weights as determined were Mₙ= 3265 g/mol and M_{w}= 6976 g/mol.

### Example 4 Carboxymethylated Polylysine Homopolymer (Polymer 4)

A 250 ml four-neck flask equipped with a stirrer, an internal thermometer, a gas inlet tube, a condenser, was charged with 7.86 g sodium chloroacetate, 37.50 g e-linear polylysine (from Yiming Biological Products Co., Ltd., Jiangsu, China, K-value 19.6) and 112.50 g D.I. water. Then, the solution was heated up to 70° C. for 5 h. During the first 1.5 h, 31.44 g sodium chloroacetate and 27.0 g sodium hydroxide (50 wt%) were added into the flask in 3 portions, every 0.5 h. The reaction mixture was treated and the product was purified in the same manner as described in Example 1 to obtain the final product with a solid content of 100 % and an active content of 95 wt%. The degree of modification (DM) as determined by¹H NMR was 53%, and the molecular weights as determined were Mₙ= 7976 g/mol and M_{w}= 8358 g/mol.

### Example 5 Carboxymethylated Polylysine Homopolymer (Polymer 5)

A 250 ml four-neck flask equipped with a stirrer, an internal thermometer, a gas inlet tube, a condenser, was charged with 61.09 g sodium chloroacetate, 38.91 g e-linear polylysine (from Yiming Biological Products Co., Ltd., Jiangsu, China, K-value 19.6) and 100.00 g D.I. water. Then, the solution was heated up to 70° C. for 16 h, meanwhile the pH was maintained at 10 by dosing 53.25 g NaOH over 2.0 h. The reaction mixture was treated and the product was purified in the same manner as described in Example 1 to obtain the final product with a solid content of 100% and an active content of 95 wt%. The degree of modification (DM) as determined by ¹H NMR was 70%, and the molecular weights as determined were Mₙ= 10167 g/mol and M_{w}= 10654 g/mol.

### Example 6 Carboxymethylated Polylysine Homopolymer (Polymer 6)

A 2000 ml four-neck flask equipped with a stirrer, an internal thermometer, a gas inlet tube, a condenser, was charged with 104.80 g sodium chloroacetate, 250.00 g e-linear polylysine (from Yiming Biological Products Co., Ltd., Jiangsu, China, K-value 19.6) and 750.00 g D.I. water. Then, the solution was heated up to 70° C. for 5 h. During the first 1.5 h, 419.20 g sodium chloroacetate and 360.00 g sodium hydroxide (50 wt%) were added into the flask in 3 portions, every 0.5 h. The reaction mixture was treated and the product was purified in the same manner as described in Example 1 to obtain the final product with a solid content of 100% and an active content of 93 wt%. The degree of modification (DM) as determined by ¹H NMR was 75%, and the molecular weights as determined were Mₙ= 10523 g/mol and M_{w}= 11027 g/mol.

### Example 7 Carboxymethylated Polylysine Homopolymer (Polymer 7)

A 500 ml four-neck flask equipped with a stirrer, an internal thermometer, a gas inlet tube, a condenser with reduced-pressure connection and a Dean-Stark receiver, was charged with 100 g aqueous solution of L-lysine (50 wt%). The mixture was heated with stirring to an internal temperature of 160° C. When the internal temperature reached 100° C., an aqueous solution of 400 g L-lysine (50 wt%) was dosed constantly over 3.5 h with continuous water separation. After a reaction time of 1 hour, water was distilled off further under reduced pressure (670 mbar). Finally, 269 g of water distillate had been collected and the highly viscous polymer was discharged to a silicone container as fast as possible while it was still hot and flowable. K-value was measured to be 12.2.

A 2000 ml four-neck flask equipped with a stirrer, an internal thermometer, a gas inlet tube, a condenser, was charged with 104.80 g sodium chloroacetate, 250.00 g polylysine and 750.00 g D.I. water. Then, the solution was heated up to 70° C. for 5 h. During the first 1.5 h, 419.20 g sodium chloroacetate and 360.00 g sodium hydroxide (50 wt%) were added into the flask in 3 portions, every 0.5 h. The reaction mixture was treated and the product was purified in the same manner as described in Example 1 to obtain the final product with a solid content of 100% and an active content of 98 wt%. The degree of modification (DM) as determined by ¹H NMR was 70%, and the molecular weights as determined were Mₙ= 2429 g/mol and M_{w}= 3825 g/mol.

### Example 8 Carboxymethylated Polylysine Homopolymer (Polymer 8)

A 500 ml four-neck flask equipped with a stirrer, an internal thermometer, a gas inlet tube, a condenser with reduced-pressure connection and a Dean-Stark receiver, was charged with 100 g aqueous solution of L-lysine (50 wt%). The mixture was heated with stirring to an internal temperature of 160° C. When the internal temperature reached 100° C., an aqueous solution of 400 g L-lysine (50 wt%) was dosed constantly over 3.5 h with continuous water separation. After a reaction time of 1 hour, water was distilled off further under reduced pressure (670 mbar). Finally, 264 g of water distillate had been collected and the highly viscous polymer was discharged to a silicone container as fast as possible while it was still hot and flowable. K-value was measured to be 11.0.

A 2000 ml four-neck flask equipped with a stirrer, an internal thermometer, a gas inlet tube, a condenser, was charged with 104.80 g sodium chloroacetate, 190.80 g polylysine and 750.00 g D.I. water. Then, the solution was heated up to 70° C. for 5 h. During the first 1.5 h, 419.20 g sodium chloroacetate and 360.00 g sodium hydroxide (50 wt%) were added into the flask in 3 portions, every 0.5 h. The reaction mixture was treated and the product was purified in the same manner as described in Example 1 to obtain the final product with a solid content of 100% and an active content of 89 wt%. The degree of modification (DM) as determined by ¹H NMR was 78%, and the molecular weights as determined were Mₙ= 1345 g/mol and M_{w}= 1986 g/mol.

### Working Examples

The carboxymethylated polylysines were studied for the chelating and dispersing performances by following methods:
Chelating Performance:
   CaCO₃ dissolution (CCD)
   Hydrogen peroxide stability (HPS)
Dispersing Performance:
   CaCO₃ dispersing capacity (CCDC)
   CaCO₃ dispersing ability (CCDA)
   CaCO₃ inhibition (CCI)

### CaCOs Dissolution (CCD)

A 100 ml dispersion of CaCO₃ (0.005 mol/L) was titrated with a 2.5 wt% solution of a polymeric additive at room temperature without stirring. The transmission was recorded till 14 ml additive solution was added. The transmission measurement was done using Metrohm Photometer 662 incl. Phototrode and Metrohm Titrino 716 DMS at pH 11 (pH was adjusted to 11 and controlled by additional pH measurement with Metrohm 654). 100 % transmission means that CaCO₃ in the system was completely dissolved. Test results are summarized in Table 1.

TABLE 1

CaCO₃ dissolution (CCD)

| Additives | Chemical | Transmission (%) |
|---|---|---|
| Modified PEI | Carboxymethylated polyethyleneimine | 82 |
| Polymer 1 | Carboxymethylated branched polylysine | 84 |
| Polymer 2 | Carboxymethylated e-polylysine | 89 |
| Polymer 3 | Carboxymethylated branched polylysine | 79 |

### Hydrogen Peroxide Stability

100 mL of aqueous solution containing a metal ion and an additive was prepared. Then, 6.67 g of 30 wt% H₂O₂ solution was added to obtain a solution comprising 2 wt% H₂O₂. The pH was adjusted to a constant value with NaOH or HCl. After stirring for a certain time, the remaining H₂O₂ content was determined by iodometric titration. Test results are summarized in Tables 2 and 3.

TABLE 2

H₂O₂ stabilization at pH 10 in presence of Fe³⁺ (120 ppm)

| Additives | Chemical | Dosage | H₂O₂ residual after 30 min (%) |
|---|---|---|---|
| None | - | - | 4 |
| EDTA Liquid | EDTA-Na₄ | 0.6 g^{a)} | 78 |
| MGDA Liquid | MGDA-Na₄ | 0.6 g^{a)} | 31 |
| Polymer 1 | Carboxymethylated branched polylysine | 0.6 g^{b)} | 38 |
| Polymer 2 | Carboxymethylated e-polylysine | 0.6 g^{b)} | 69 |
| Polymer 3 | Carboxymethylated branched polylysine | 0.6 g^{b)} | 24 |

a) on a basis of active content
b) on a basis of solid content

TABLE 3

H₂O₂ stabilization at pH 9 in presence of Mn²⁺ (60 ppm)

| Additives | Chemical | Dosage | H₂O₂ residual after 60 min (%) |
|---|---|---|---|
| None | - | - | 0 |
| EDTA Liquid | EDTA-Na₄ | 0.6 g^{a)} | 84 |
| MGDA Liquid | MGDA-Na₄ | 0.6 g^{a)} | 34 |
| Polymer 1 | Carboxymethylated branched polylysine | 0.6 g^{b)} | 68 |
| Polymer 2 | Carboxymethylated e-polylysine | 0.6 g^{b)} | 56 |
| Polymer 3 | Carboxymethylated branched polylysine | 0.6 g^{b)} | 66 |

a) on a basis of active content
b) on a basis of solid content

### CaCO₃ Dispersing Ability (CCDA)

Titrations of CaCl₂ into Na₂CO₃ solution were performed using a commercial titration system from Metrohm. The setup consists of a titration device (Titrando 905), which operates two dosing units (Dosino 807). The turbidity was monitored using an optrode (Metrohm, No. 6.1115.000). A 60 ml aqueous solution containing 400 ppm Ca²⁺ was poured into a 60 ml aqueous solution containing 600 ppm CO₃²⁻ and 200 ppm additive on a basis of active content, as fast as possible under stirring. The turbidity of the mixture was recorded at pH 11 and 25° C. during 30 min. Test results are summarized in Table 4.

TABLE 4

CaCO₃ dispersing ability (CCDA)

| Additives | Chemical | Transmission (%) | |
|---|---|---|---|
| | | 700 s | 1800 s |
| None | - | 5 | 0 |
| MGDA Liquid | MGDA-Na₄ | 11 | 0 |
| HEDP | 1-Hydroxyethylidene-1,1-diphosphonic acid | 66 | 54 |
| Polymer 2 | Carboxymethylated e-polylysine | 91 | 81 |
| Polymer 3 | Carboxymethylated branched polylysine | 75 | 63 |

### CaCO₃ Dispersing Capacity (CCDC)

The calcium carbonate dispersing capacity (CCDC) allows the quantification of the ability of a polymeric dispersing agent to inhibit the precipitation of calcium carbonate in aqueous media.

1.0 g of a polymeric additive on a basis of solid content was dissolved in 100 ml water. Then, 10 ml of 10 wt% sodium carbonate solution was added. The pH value of the test solution was adjusted to pH 11 with 1 N NaOH. The test solution was titrated against a 0.25 M calcium acetate solution till it starts to become turbid. During titration the pH was kept constant by adjusting with 1 N NaOH or 1 N HCl. Test results are summarized in Table 5.

TABLE 5

CaCO₃ dispersing capacity (CCDC)

| Additives | Chemical | CCDC (mg CaCO₃/ g additive) |
|---|---|---|
| Polymer PA-1 | Polyacrylic acid, Na-salt | 120 |
| Polymer 1 | Carboxymethylated branched polylysine, DM 89% | 195 |
| Polymer 2 | Carboxymethylated e-polylysine, DM 90% | 165 |
| Polymer 3 | Carboxymethylated branched polylysine, DM 80% | 160 |
| Polymer 4 | Carboxymethylated e-polylysine, DM 53% | 60 |
| Polymer 5 | Carboxymethylated e-polylysine, DM 70% | 77 |

### Calcium Carbonate Inhibition (CCI)

The calcium carbonate inhibition (CCI) is a measure of the ability of the polymeric additive to inhibit or retard the precipitation of poorly soluble calcium salts (e.g. CaCO₃) during the application.

A beaker containing a solution of 215 mg/l Ca²⁺, 43 mg/l Mg²⁺, 1220 mg/l HCO₃⁻ , 460 mg/l Na⁺, 380 mg/l Cl⁻, 170 mg/l SO₄²⁻ and 3 or 5 ppm additive (on a basis of active content for a non-polymeric additive or solid content for a polymeric additive) at a pH of approx. 8.0 - 8.3 was placed in a shaking water bath at 70° C. for 2 hours. After filtration of the warm solution, the Ca²⁺ concentration of the filtrate was determined by titration with 0.01 M EDTA-Na₄ and the degree of inhibition was calculated. Test results are summarized in Table 6.

TABLE 6

CaCOs inhibition (CCI)

| Additives | Chemical | CCl (%) | |
|---|---|---|---|
| | | 3 ppm | 5 ppm |
| MGDA liquid | Methylglycinediacetic acid (MGDA) | 8 | 12 |
| Modified PEI | Carboxymethylated polyethyleneimine | 22 | 38 |
| Polymer 2 | Carboxymethylated e-polylysine | 46 | 68 |
| Polymer 3 | Carboxymethylated branched polylysine | 35 | 56 |
| Polymer 4 | Carboxymethylated e-polylysine | 27 | 34 |
| Polymer 5 | Carboxymethylated e-polylysine | 39 | 51 |

It can be seen that the carboxymethylated polylysines according to the present invention shows acceptable or desirable dispersing and chelating abilities which are required by detergent compositions. Further, the carboxymethylated polylysines according to the present invention shows desirable ability to stabilize hydrogen peroxide against heavy metal ions.

### Application Examples

The carboxymethylated polylysines were studied for the performance thereof in detergent applications and in pulp bleaching application.

### Compatibility in Liquid Laundry Formulation

The carboxymethylated polylysines were studied for the liquid laundry formulation compatibility with a concentrated detergent formulation as shown in Table 7. Stability of the formulations comprising 1% additive concentration and being adjusted to a pH of 8.5 upon a week were observed visually. The test results are summarized in Table 8.

TABLE 7

Formulation 01

| | |
|---|---|
| Ingredients | Amount^{a)}, wt% |
| Anionic Surfactant DBS | 6.0 |
| Non-ionic Surfactant AEO-2 | 24.0 |
| Sodium Citrate | 0.5 |
| Ethanol | 1.5 |
| Propylene glycol | 5.0 |
| Additive as shown in Table 8 | 1.0 |
| Water | up to 100 |

a) on a basis of active content for a non-polymeric ingredient and on a basis of solid content for a polymeric ingredient

TABLE 8

| | | |
|---|---|---|
| Additive | Chemical | 1.0%,7 days |
| Blank | - | Clear |
| Polymer PA-1 | Polyacrylic acid, Na-salt | Phase separation |
| Polymer 1 | Carboxymethylated branched polylysine | Clear |
| Polymer 2 | Carboxymethylated e-polylysine | Clear |
| Polymer 3 | Carboxymethylated branched polylysine | Clear |

It can be seen that the carboxymethylated polylysines show good compatibility in a concentrated liquid detergent formulation at a high pH.

### Antigreying Performance of a Liquid Laundry Formulation

Detergent formulations as shown in Table 9 were used to evaluate the anti-greying performances.

TABLE 9

Formulation 02

| | |
|---|---|
| Ingredients | Amount^{a)}, wt% |
| Anionic Surfactant DBS | 5.5 |
| Edenor® K12-18 | 2.4 |
| Anionic Surfactant AES | 5.4 |
| NaOH | 2.2 |
| Non-ionic Surfactant AEO-1 | 5.4 |
| 1,2-Propylene glycol | 6.0 |
| Ethanol | 2.0 |
| Additive as shown in Table 11 | 1.0 or 3.0 |
| Water | up to 100 |

a) on a basis of active content for a non-polymeric ingredient and on a basis of solid content for a polymeric ingredient

A laundering process was simulated with Launder-o-meter (LP2 Typ, SDL Atlas Inc., USA).

White test fabrics were washed in the same beaker together with 2.5 g clay dispersion and 20 steel balls at 40° C. in a wash liquor comprising a detergent of Formulation 02, and then rinsed and spin-dried for completing a wash cycle. The wash cycle was repeated two times with new clay dispersion and new wash liquor. After the rinsing in the third wash cycle, the test fabrics were dried in the air instead. The details of the wash cycles are summarized in Table 10.

The anti-greying performance was characterized by Remission ΔR value of the soiled fabric before and after wash and determined by measuring the fabric with the spectrophotometer Elrepho 2000 from Datacolor at 460 nm. The higher the Remission ΔR value, the better is the performance. Results were summarized in Table 11.

TABLE 10

| | |
|---|---|
| Equipment | Launder-o-meter |
| Detergent dosage | 2 g/L and 5 g/L |
| Detergent | Formulation 02, 20% |
| Water hardness | 2.5 mmol/L, Ca²⁺: Mg²⁺: HCO₃⁻ 4:1:8 |
| Ca: Mg: HCO3⁻ | 4:1:8 |
| Washing time/temperature | 20 min at 40° C. |
| Wash cycles | 3 |
| Wash liquor | 250 ml |
| Fabric/liquor ratio | 1 kg fabric/10 L water |
| White test fabric (each 10 × 10 cm) | wfk20A |
| | wfk30A |
| | EMPA 406 |
| Test soil | 2.5 g Clay dispersion consisting of 20% wfk clay 05203, 5% peanut oil/mineral oil (3:1) and 75% water |

TABLE 11

| Detergent dosage | 2 g/L | | 5 g/L |
|---|---|---|---|
| Blank | 189.2 | | 193.0 |
| Additive dosage | 1 wt% | 3 wt% | 3 wt% |
| Polymer PA-2 | 192.4 | 196.5 | - |
| Polymer PA-1 | 191.8 | 184.4 | - |
| Polymer 6 | 191.5 | 199.6 | 199.8 |
| Polymer 7 | 190.7 | - | 196.0 |
| Polymer 8 | - | 193.5 | 197.6 |

It can be seen that the carboxymethylated polylysines show acceptable anti-greying performance, which is even comparable to the commercially available polymeric additives.

### Stain Removal Performance of a Liquid Laundry Formulation

Detergent formulations as shown in Table 12 were used to evaluate the stain removal performance.

TABLE 12

| | Formulation 03 | Formulation 04 |
|---|---|---|
| Ingredients | Amounts^{a)}, wt% | Amounts^{a)}, wt% |
| Anionic Surfactant DBS | 5.5 | 5.5 |
| Edenor® K12-18 | 2.4 | 2.4 |
| Anionic Surfactant AES | 5.4 | 5.4 |
| NaOH | 2.2 | 2.2 |
| Non-ionic Surfactant AEO-1 | 5.4 | 5.4 |
| 1,2-Propylene glycol | 6.0 | 6.0 |
| Ethanol | 2.0 | 2.0 |
| Additive as shown in Table 14 | 1.0 or 3.0 | 3.0 |
| Sodium citrate | - | 3.0 |
| DTPMPA | - | 0 or 0.5 |
| Water | up to 100 | up to 100 |

a) on a basis of active content for a non-polymeric ingredient and on a basis of solid content for a polymeric ingredient

A laundering process was simulated in lab using Launder-o-meter (LP2 Typ, SDL Atlas Inc., USA).

Several stained test fabrics were washed together with cotton ballast fabric and 20 steel balls at 25° C. in a wash liquor comprising the detergent of the specified formulation. After the washing, the fabrics were rinsed, spin-dried and dried in the air. The details of the washing conditions are summarized in Table 13.

The stain removal performance is characterized by ΔE value calculated according to DIN EN ISO 11664-4 (June 2012) in accordance with following equation:

$$Δ \text{E} \text{=} {\left(Δ {\text{L}}^{* 2} + Δ {\text{a}}^{* 2} + Δ {\text{b}}^{* 2}\right)}^{1 / 2} ,$$

in which

$$Δ {\text{L* = L*}}_{\text{washed}} {\text{- L*}}_{\text{initial}} ;$$

$$Δ {\text{a}}^{*} = {\text{a*}}_{\text{washed}} {\text{- a*}}_{\text{initial}} ; \text{and}$$

$$Δ {\text{b}}^{*} = {\text{b*}}_{\text{washed}} {\text{- b*}}_{\text{initial}} .$$

The L*, a*, b* values were measured on the stained fabrics before and after washing with the spectrophotometer Elrepho 2000 from Datacolor. The higher the ΔE value, the better is the performance. Test results are summarized in Table 14 to 15.

TABLE 13

| | |
|---|---|
| Test equipment | Launder-o-meter |
| Washing liquor | 250 ml |
| Washing time/temperature | 20 min at 25° C. |
| Detergent dosage | 2 g/L or 4 g/L |
| Fabric/liquor ratio | 1 : 12.5 (kg/L) |
| Washing cycles | 1 |
| Water hardness | 2.5 mmol/l Ca²⁺: Mg²⁺: HCO3⁻ / 4:1:8 |
| Ballast fabric | 10 g cotton fabric BW 283 from Reichenbach |
| Soiled fabric | 10 g |
| Soiled fabric | EMPA 117 (blood/milk/ink), wfk 10J (tea) |

TABLE 14

Test results of washing EMPA 117 with the detergent of Formulation 03 at the detergent dosage of 2 g/L

| | | |
|---|---|---|
| Blank | 10.4 | |
| Additive dosage | 1.0 wt % | 3.0 wt% |
| Polymer 6 | 12.9 | 14.3 |
| Polymer 7 | 11.7 | 14.3 |
| Polymer 8 | 12.8 | 16.2 |
| Modified PEI | 13.2 | 12.4 |

TABLE 15

Test results of washing Wfk 10J with the detergent of Formulation 04 at the detergent dosage 4 g/L

| | Without DTPMPA | With DTPMPA |
|---|---|---|
| Blank | 6.3 | 7.2 |
| Modified PEI | 7.2 | 7.6 |
| Polymer 6 | 7.2 | 7.7 |
| Polymer 7 | 7.0 | 7.5 |
| Polymer 8 | 7.4 | 7.2 |

The test results demonstrate that the carboxymethylated polylysines show stain removal effect which is comparable or even better than the commercially available polymeric additive.

### Anti-filming Performances of an Automatic Dishwashing Formulation

A build-up test was performed in accordance with the general procedure as detailed in Table 16.

TABLE 16

| Dishwasher | Miele G 1222 SCL |
|---|---|
| Program | 65° C. in main cycle (with prewash), 65° C. rinse temperature, no rinse aid was used, no regenerating salt for ion exchange resin was used |
| Dishes | 3 knives (WMF Tafelmesser Berlin, monobloc) |
| | 3 Amsterdam 0.2 L drinking glasses |
| | 3 “OCEAN BLAU” breakfast plates (MELAMINE) |
| | 3 porcelain plates: 19 cm plates with rims flat |
| Ballast dishes | 8 tea cups, 8 porcelain plates |
| Arrangement | Knives in the cutlery drawer, glasses in the upper baskets, plates in the lower basket |
| Dosage | 18 g of dishwashing detergent |
| Ballast soil | 50 g of ballast soil is added with the formulation after the prewash; for composition see below |
| Water hardness | 21° German hardness (Ca/Mg): HCO₃ (3:1):1.35 |
| Cycles | 30; break in between for 1 h in each case (10 min with door open, 50 min with door closed) |
| Evaluation: | Visually after 30 cycles |
| Starch | 0.5% potato starch, 2.5% gravy |
| Fat | 10.2% margarine |
| Protein | 5.1% egg yolk, 5.1% milk |
| Others | 2.5% tomato ketchup, 2.5% mustard, 0.1% benzoic acid, 71.4% water |
| Composition of the Ballast Soil | |
| Starch | 0.5% potato starch, 2.5% gravy |
| Fat | 10.2% margarine |
| Protein | 5.1% egg yolk, 5.1% milk |
| Others | 2.5% tomato ketchup, 2.5% mustard, 0.1% benzoic acid, 71.4% water |

Dishes after 30 cycles were evaluated visually in a darkened chamber under light behind an aperture diaphragm using a grading scale from 10 (very good) to 1 (very poor). Scores from 1-10 for filming (1 = very severe filming, 10 = no filming) were awarded.

The build-up test was performed with a tablet Formulation without HEDP and with citrate as shown in Table 17. The test results of filming evaluation are summarized in Table 18.

TABLE 17

Formulation 05

| Ingredients | Amounts^{a)}, wt% |
|---|---|
| Blaze® Evity® 150T | 2.5 |
| Stainzyme® Plus Evity® 12L | 1.0 |
| Dehypon® E 127 & Dehypon® GRA (weight ratio 4/1) | 5.0 |
| Additive as shown in Table 18 | 5.0 |
| Sodium percarbonate | 10.2 |
| Tetraacetylethylenediamine | 4.0 |
| Na₂Si₂O₅ (Britesil H 265 LC) | 2.0 |
| Na₂CO₃, Solvay Soda schwer | 24.5 |
| Na-Citrate dihydrate | 35.0 |
| MGDA Granules | 10.0 |
| Water | 0.8 |

a) on a basis of active content for a non-polymeric ingredient and on a basis of solid content for a polymeric ingredient

TABLE 18

| | Knives | Glass | Plastic | China | Sum |
|---|---|---|---|---|---|
| Blank | 3.0 | 2.0 | 3.7 | 3.7 | 12.4 |
| Polymer PA-1 | 6.0 | 5.0 | 6.3 | 6.7 | 24.0 |
| Modified PEI | 4.7 | 4.0 | 5.7 | 5.7 | 20.1 |
| Polymer PAA | 5.3 | 5.0 | 6.0 | 6.0 | 22.3 |
| Polymer 7 | 5.0 | 4.3 | 5.3 | 5.3 | 19.9 |

The build-up test was performed with a tablet Formulation with HEDP and with citrate as shown in Table 19. The test results of filming evaluation are summarized in Table 20.

TABLE 19

Formulation 06

| Ingredients | Amounts^{a)}, wt% |
|---|---|
| Blaze® Evity®150T | 2.5 |
| Stainzyme® Plus Evity®12L | 1.0 |
| Dehypon® E 127 & Dehypon® GRA (weight ratio 4/1) | 5.0 |
| Additive as shown in Table 20 | 5.0 |
| Sodium percarbonate | 10.2 |
| Tetraacetylethylenediamine | 4.0 |
| Na₂Si₂O₅ (Britesil H 265 LC) | 2.0 |
| Na₂CO₃, Solvay Soda schwer | 24.5 |
| Na-Citrate dihydrate | 35.0 |
| HEDP ((Cublen K 8514 GR) | 5.0 |
| Na-Sulfate (anhydrous) | 5.8 |

a) on a basis of active content for a non-polymeric ingredient and on a basis of solid content for a polymeric ingredient

TABLE 20

| | Knives | Glass | Plastic | China | Sum |
|---|---|---|---|---|---|
| Blank | 5.0 | 4.3 | 6.7 | 6.7 | 22.7 |
| Polymer 7 | 6.0 | 5.0 | 7.3 | 6.3 | 24.6 |
| Polymer PA-1 | 4.0 | 4.0 | 5.0 | 5.0 | 18.0 |
| Polymer PAA | 6.3 | 5.0 | 6.7 | 6.7 | 24.7 |

The test results demonstrate that the carboxymethylated polylysine shows anti-filming effect which is comparable or even better than the commercially available polymeric additives.

### Pulp Bleaching Application

An aqueous suspension containing 4.0 wt% of groundwood cellulose fibers, 1.5 wt% of hydrogen peroxide (10%) and 0.2 wt% of an additive relative to the amount of cellulose fibers, 0.75 wt% of sodium hydroxide and 2.0 wt% of sodium silicate was heated up to 70° C. After 1.5 h, the fibers were filtered, and then the filter cake was pressed and dried to a sheet of paper. The degree of Tappi whiteness of the dried sheet wasw determined by Datacolor DC 400 from Datacolor. The test results are summarized in Table 21.

TABLE 21

| Additive | Blank | EDTA Liquid | Polymer 6 | Polymer 7 | Polymer 8 |
|---|---|---|---|---|---|
| Dosage | - | 0.2%^{a)} | 0.2% ^{b)} | 0.2% ^{b)} | 0.2% ^{b)} |
| Tappi Whiteness degree | 60.1 | 63.3 | 63.8 | 64.0 | 63.6 |

a) on a basis of active content, b) on a basis of solid content

The test results demonstrate that the carboxymethylated polylysines could stabilize hydrogen peroxide to an extent comparable or even better than the conventional chelating agent.

1. A method of using carboxymethylated polylysines having a degree of modification (DM) of at least 50%, the method comprising using the carboxymethylated polylysines as dispersing agents and/or chelating agents.

2. The method of use according to claim 1, wherein the carboxymethylated polylysines are prepared from polylysines having a K-value in the range of 8 to 25, or wherein the carboxymethylated polylysines have a number average molecular weight (Mn) in the range of 800 to 17,000 g/mol, and/or have a weight average molecular weight (Mw) in the range of 900 to 18,000 g/mol.

3. The method of use according to claim 1 , wherein the carboxymethylated polylysines are linear or branched carboxymethylated polylysines.

4. The method of use according to claim 1, wherein the carboxymethylated polylysines are carboxymethylated ε-linear polylysines.

5. A detergent composition or a peroxy bleaching composition, which comprises carboxymethylated polylysines having a degree of modification (DM) of at least 50%.

6. The composition according to claim 5, wherein the carboxymethylated polylysines are prepared from polylysines having a K-value in the range of 8 to 25, or wherein the carboxymethylated polylysines have a number average molecular weight (Mn) in the range of 800 to 17,000 g/mol, and/or have a weight average molecular weight (Mw) in the range of 900 to 18,000 g/mol.

7. The composition according to claim 5, wherein the carboxymethylated polylysines are linear or branched carboxymethylated polylysines.

8. The composition according to claim 5, wherein the carboxymethylated polylysines are carboxymethylated ε-linear polylysines.

9. The composition according to claim 5, which is a laundry detergent composition or a detergent composition for cleaners.

10. The composition according to claim 5, wherein the detergent composition comprises 0.1 to 80% by weight of at least one surfactant selected from the group consisting of anionic surfactants, amphoteric surfactants and nonionic surfactants.

11. The composition according to claim 5, wherein the detergent composition comprises the carboxymethylated polylysines in an amount of 0.5 to 30%, by weight based on the total solid content of the detergent composition.

12. The composition according to claim 5, which is a peroxy bleaching composition for bleaching cellulosic fibrous material selected from the group consisting of wood, cotton, linen, jute and other materials of a cellulosic nature, which may be in form of individual fibers as well as yarns, tows, webs, fabrics and other aggregates of such fibers and for bleaching synthetic textiles selected from the group consisting of polyamides, viscose, rayon and polyesters.

13. The composition according to claim 5, wherein the peroxy bleaching composition comprises hydrogen peroxide or a precursor of hydrogen peroxide.

14. The composition according to claim 13, wherein the peroxy bleaching composition is in a form of aqueous hydrogen peroxide solution, based on the total weight of the solution.

15. A method of using the carboxymethylated polylysines as defined in claim 1, the method comprising using the carboxymethylated polylysines in a detergent composition or a peroxy bleaching composition.

16. A process for bleaching cellulose fiber pulps with a peroxy bleaching agent, wherein the carboxymethylated polylysines as defined in claim 1 are used as a stabilizer of the peroxy bleaching agent.

17. The process according to claim 16, wherein the carboxymethylated polylysines are incorporated into the cellulose fiber pulps in a dosage of 0.01 to 3% by weight, based on the weight of the cellulose fiber pulps.

18. A method for formulating a detergent composition or a peroxy bleaching composition, the method comprising formulating the detergent composition or the peroxy bleaching composition with the carboxymethylated polylysines as defined in claim 1.

19. The method of use according to claim 1, wherein the carboxymethylated polylysines have a degree of modification (DM) of at least 70%.

20. The method of use according to claim 1, wherein the carboxymethylated polylysines have a degree of modification (DM) of at least 80%.
